(19) United States
(12) Patent Application Publication
(10) Pub. No.: US 2016/0329178 A1
(43) Pub. Date: Nov. 10, 2016

(54) MANUFACTURED PIECE FOR A GAS-INSULATED HIGH-VOLTAGE CIRCUIT BREAKER TANK WITH PARTICLE TRAPS AND TANK CONTAINING SUCH A PIECE

(71) Applicant: ALSTOM Technology Ltd, Baden (CH)

(72) Inventors: Victor F. HERMOSILLO, BETHEL PARK, PA (US); Andrew CHOVANEC, BLAIRSVILLE, PA (US); Steven GROSICK, STOCKDALE, PA (US); Matthias SCHIRMER, FINLEYVILLE, PA (US); Keith MCLAUGHLIN, ELIZABETH, PA (US)

(21) Appl. No.: 14/704,870

(22) Filed: May 5, 2015

(51) Int. Cl. H01H 33/56

(52) U.S. Cl. CPC H01H 33/56

(57) ABSTRACT

A manufactured piece of a tank made by casting or molding for a high-voltage circuit breaker is provided. It comprises a hollow body with at least one wall extending longitudinally along a main axis to delimit a cavity with two ends, a top and a bottom; at least one opening in the top of the body; and at least one particle trap in the bottom of the body for collecting particles. The particle trap is a groove extending between two set apart points belonging to a plan perpendicular to the main axis, the groove preferably extending in a plan perpendicular to the main axis.

### TECHNICAL FIELD

The present invention relates to gas-insulated high-voltage circuit breakers and more particularly to circuit breakers having particle traps.

### STATE OF THE PRIOR ART

In circuit breakers, the presence or generation of particles of dielectric or metallic material (for example, by parts which rub mechanically against one another or by the damage and surface wear of the arcing contacts caused by the formation of electric arcs) in the tank can trigger a voltage breakdown between live and grounded parts. Indeed, conductive particles move towards the highest dielectrically stressed live parts. These particles can lift-off, float or stand-up under the influence of the voltage, reducing the required dielectric clearance and increasing the voltage gradients, possibly leading to a dielectric breakdown of the gap between the interrupter and the tank.

In order to assure effective circuit breaker operation, nowadays tanks are equipped with means for trapping the particles.

These particle traps are disposed along the surface of the tank and are generally depressions or cavities formed into the wall of the tank, in which zero or near zero electric fields are created. In operation, particles are guided to the particle trap by an electric field which exists between the live and grounded parts of the circuit breaker and are trapped by the low electric field in the trap.

A circuit breaker tank 30 with a circular well-shaped particle trap 19 is described in the patent U.S. Pat. No. 7,858,877 and illustrated in FIG. 1. In the illustrated embodiment of the prior art, the bottom wall of the tank is inclined in the direction of the particle traps 19 and the particle traps 19 are covered by covering shrouds 13.

In the patent U.S. Pat. No. 6,307,172 is described a tank 30 with a particle trap 29 in the form of a channel axially directed relative to a longitudinal axis of the tank and extending substantially between both ends of the tank (FIG. 2 and FIG. 3).

The longitudinal particle trap 29 design and the well particle trap 19 design both have the disadvantage that they are effective for a tank with vertical poles, the effectiveness of the particle traps being reduced for inclined poles.

To obtain the best effectiveness, the particle trap must be disposed on the surface of the tank that meets a vertical line (bottom). Accordingly, as circuit breaker tanks are manufactured by molding or casting, three different molds and three different tanks would have to be designed to have the particle traps at the bottom for vertical and inclined poles in a three-phase circuit breaker assembly, increasing the costs and the manufacturing time needed. An exemplary three-phase circuit breaker assembly 41 is illustrated in FIG. 4 and includes three tanks 30 mounted on a frame 39 and with external poles 40 inclined with respect to the vertical axis, the central pole being vertical and the external poles being inclined away from the center pole.

The proposed invention will allow the overall optimization of the manufacturing of a tank with particle trap to decrease the time and costs needed for the manufacturing of effective tanks, in particular for the realisation of two-phase and three-phase circuit breakers with external poles inclined with respect to the vertical axis.

### DISCLOSURE OF THE INVENTION

To that end, the invention provides a manufactured piece of a tank made by casting or molding for a high-voltage circuit breaker, having:
a hollow body with at least one wall extending longitudinally along a main axis to delimit a cavity with two ends, a top and a bottom;
at least one opening in the top of the body; and
at least one particle trap in the bottom of the body for collecting particles;
wherein the particle trap is a groove extending between two set apart points belonging to a plan perpendicular to the main axis.

According to a preferred embodiment of the invention, the groove extends in a plan perpendicular to the main axis.

Preferably, the groove is defined by the wall of the body and opens to the cavity.

According to a preferred embodiment of the invention, the angular distance at the main axis of the body between the two set apart points ( ) depends on the inclination of the external poles such that the trap is present at a six o'clock position under the interrupter. Typical pole inclinations (vary between 15 and 45 degrees from the vertical axis. Consequently, this angular distance can be comprised between 40 and 100 degrees.

The groove has a depth that depends on the groove width, since the electric field intensity on the lower surface of the groove has to be low. In the present invention, typical ratios of width to depth are comprised between 0.5 and 3.0.

In a preferred embodiment of the invention, the body is generally cylindrical in shape.

Advantageously, the manufactured piece further comprises a covering shroud placed at a particle trap, said shroud being formed with a shielding surface for dielectrically shielding an area between the covering shroud and a bottom of the groove. Preferably, the body is generally cylindrical in shape and a top surface of the covering shroud is flush with a surface of the body wall around the groove.

Another object of the invention is a tank for a high-voltage circuit breaker, having a casing with at least one inner wall extending longitudinally along an axis to delimit an interior chamber with two ends, a top and a bottom, two particle traps in the bottom of the casing and two openings in the top of the casing, wherein the tank comprises a manufactured piece according to the invention, the cavity of the hollow body forming at least part of the interior chamber of the tank.

According to a first embodiment, the tank contains one manufactured piece, the interior chamber of the tank corresponding to the cavity of the manufactured piece. In the first embodiment, the tank is thus a single-piece tank.

According to a second embodiment, the tank contains two manufactured pieces, the interior chamber of the tank corresponding to two cavities and resulting from the assembling of one end of a first manufactured piece with one end of a second manufactured piece. In the second embodiment, the tank is thus a two-piece tank. Preferably, the first and second manufactured pieces are identical.

Advantageously, the interior chamber is composed of section areas arranged longitudinally along the axis of the casing, with two end section areas at the ends, two opening section areas at the openings and a central section area, each opening area being located between an end section area and the central section area; in this preferred embodiment, the two particle traps are located in the central section area.

In a preferred embodiment, the tank further comprises two additional particle traps, an additional particle trap being located in each of the two opening section areas. Accordingly, in this preferred embodiment, the tank comprises four particle traps: two particle traps are located in the central section area, near the interrupter gap, and two particle traps are located near the ends of the tank, in proximity to the interrupter ends. In particular, one particle trap is located in an end section area and another particle trap is located in the other end section area.

The tank may be a two-piece tank, but is preferably a single-piece tank. Accordingly, in a preferred embodiment, the tank consists of a single-piece tank with four particle traps, two particle traps being located in the central section area (near the interrupter gap) and two particle traps, each being located in one of the two opening area, near the ends of the tank.

Another object of the invention is a high-voltage gas-insulated circuit breaker comprising an interrupter chamber enclosed in a tank filled with insulating gas, wherein the tank is a tank according to the invention.

An advantage of the present invention is to propose a tank for a circuit breaker which is obtained by an unique mold and which allows rotation of the tank angle around its longitudinal axis for outside poles, for the realisation of two-phase or three-phase circuit breakers.

Another advantage of the present invention is the possibility to manufacture a single piece tank or a two-piece tank, by assembling two casted or molded pieces together, which is appreciable when manufacturing large tanks.

A further advantage of the present invention is to provide a tank for a circuit breaker which is made with minimal loss of structural integrity of casting and insignificant addition of cast material.

Additional features and advantages of the present invention are described in, and will be apparent from, the detailed description of the preferred embodiments, the figures and the claims.

### BRIEF DESCRIPTION OF THE FIGURES

FIG. 1 is a schematic sectional side view of a tank of the prior art with two well-shaped particle traps.

FIG. 2 is a schematic sectional side view of a tank of the prior art with a channel-shaped particle trap extending substantially between both ends of the tank.

FIG. 3 is a schematic sectional side view of the tank as taken generally along line A-A of FIG. 2.

FIG. 4 is a perspective view of a three-phase circuit breaker.

FIG. 5 is a schematic sectional side view of a manufactured piece according to an embodiment of the present invention.

FIG. 6 is a schematic sectional side view of a tank of the present invention, obtained by the assemblage of two identical pieces of FIG. 5.

FIG. 7 is a schematic sectional side view of a manufactured piece according to another embodiment of the present invention (a single-piece tank with two particle traps).

FIG. 8 is a perspective view of the tank illustrated in FIG. 7.

FIG. 9 is a schematic sectional side view of a manufactured piece according to another embodiment of the present invention (a single-piece tank with four particle traps).

FIG. 10 is a perspective view of the tank illustrated in FIG. 9.

FIG. 11 is a perspective view of the tank of FIG. 8 with a schematic sectional side view of the tank as taken along line B-B of FIG. 8.

FIG. 12 is a schematic sectional side view of a detail of FIG. 8 showing electric fields vectors generally indicating the strength of the electrical field on the surface near and at the particle trap.

FIG. 13 is a partial perspective view taken along longitudinal axis 20 of a tank with a particle trap equipped with a shrouding covering according to an embodiment of the invention.

FIG. 14 is a partial schematic sectional side view of a tank as taken along line C-C of FIG. 13.

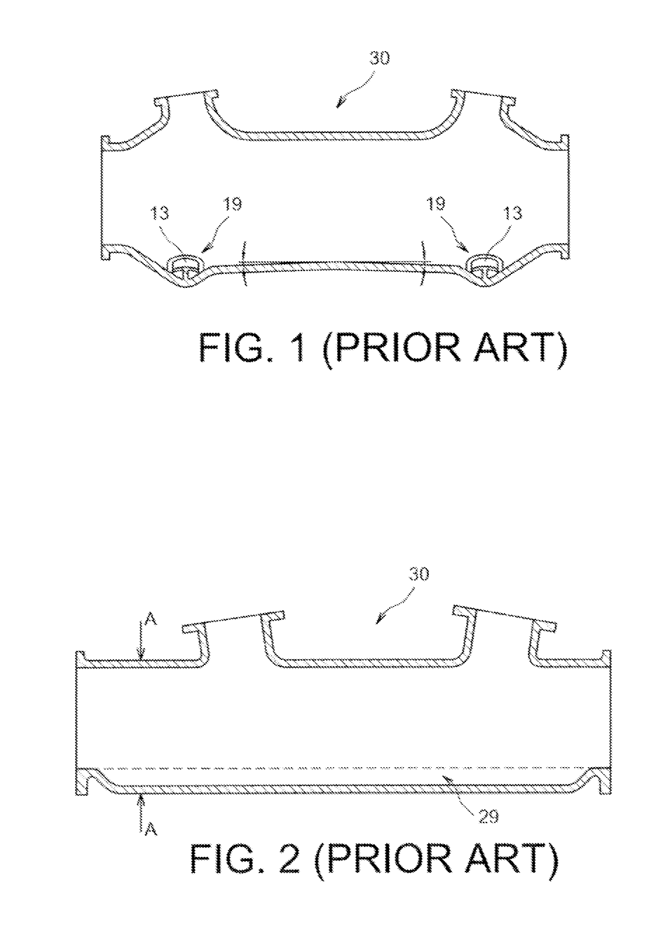

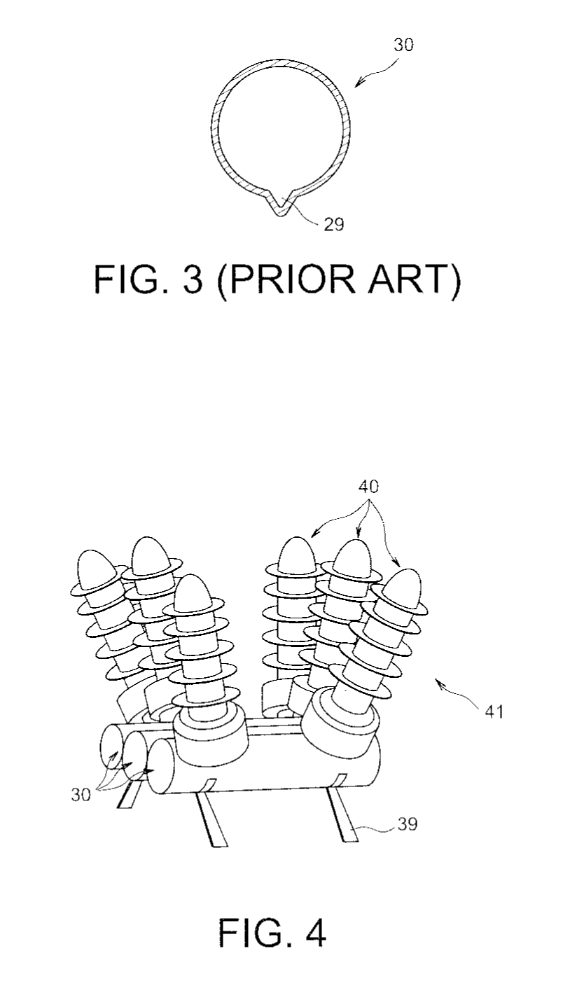

### DETAILED DESCRIPTION OF PREFERRED EMBODIMENTS OF THE INVENTION

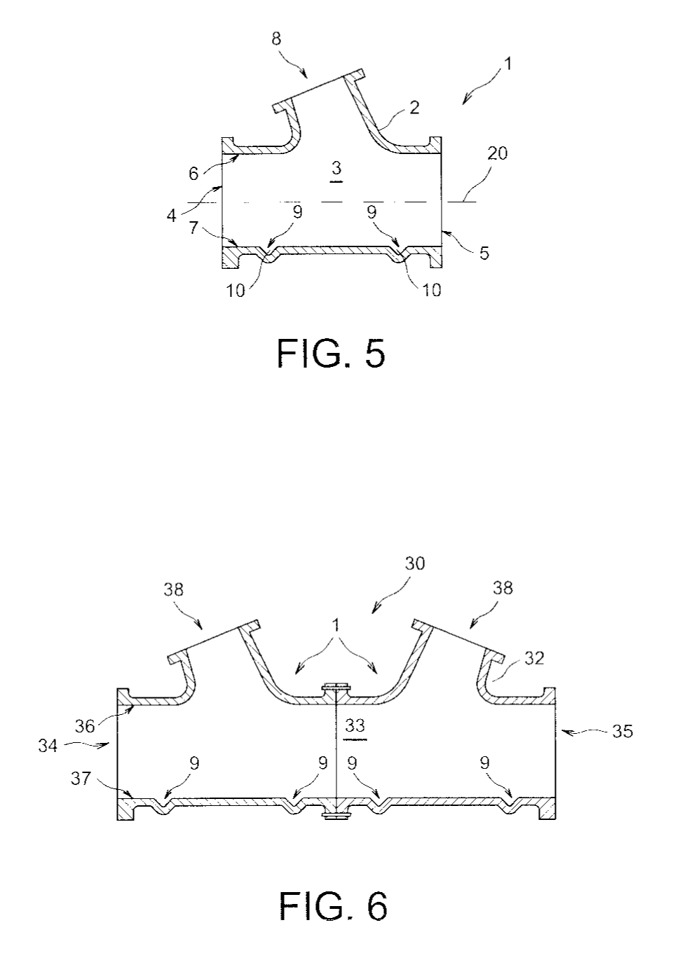

FIG. 5 illustrates a manufactured piece 1 of a tank 30 for a high-voltage circuit breaker according to the invention, made by casting or molding. The piece 1 comprises a hollow body with at least one wall 2 extending longitudinally along a main axis 20 to delimit a cavity 3 with two ends 4, 5, a top 6 and a bottom 7, an opening 8 in the top of the body and two particle traps 9 in the bottom 7 of the body.

FIG. 6 illustrates a tank 30 having a casing 31 with at least one inner wall 32 extending longitudinally along an axis to delimit an interior chamber 33 with two ends 34, 35, a top 36 and a bottom 37, four particle traps 9 in the bottom of the casing and two openings 38 in the top of the casing. In this embodiment, the tank 30 is a two-piece tank, comprising two identical pieces 1 assembled together.

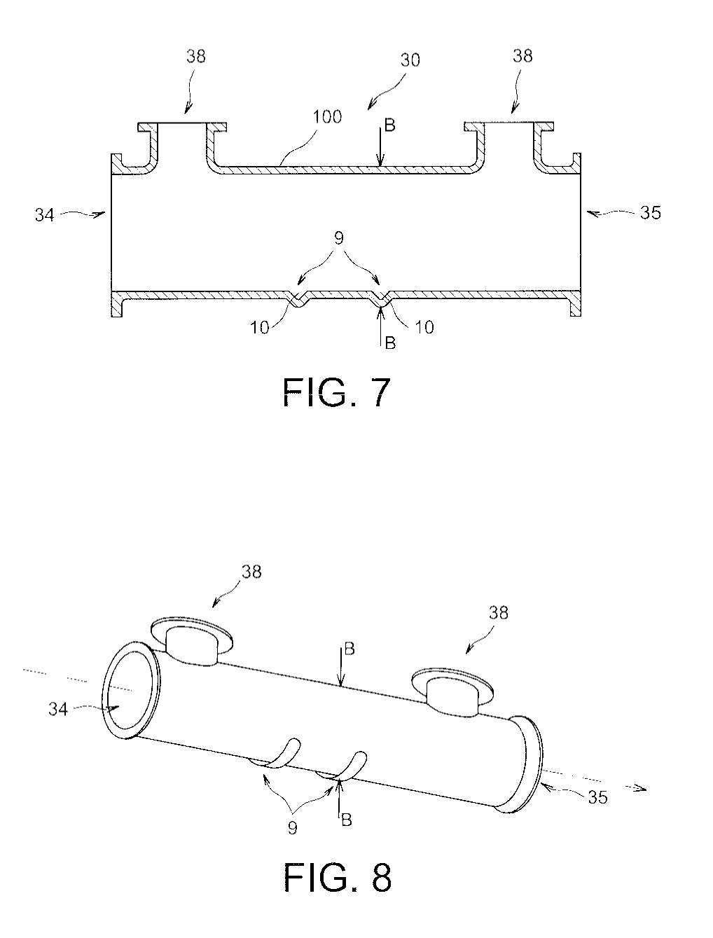

FIG. 7 illustrates a tank 30 having two particle traps 9, the tank 30 being made of a single piece 100.

According to the invention, the particle trap 9 is a groove extending between two set apart points belonging to a plan perpendicular to the main axis of the piece 1 or 100. Preferably, the groove extends in a plan perpendicular to the main axis of the tank as illustrated in FIG. 8, wherein two radial troughs are formed in the wall of the tank at its bottom.

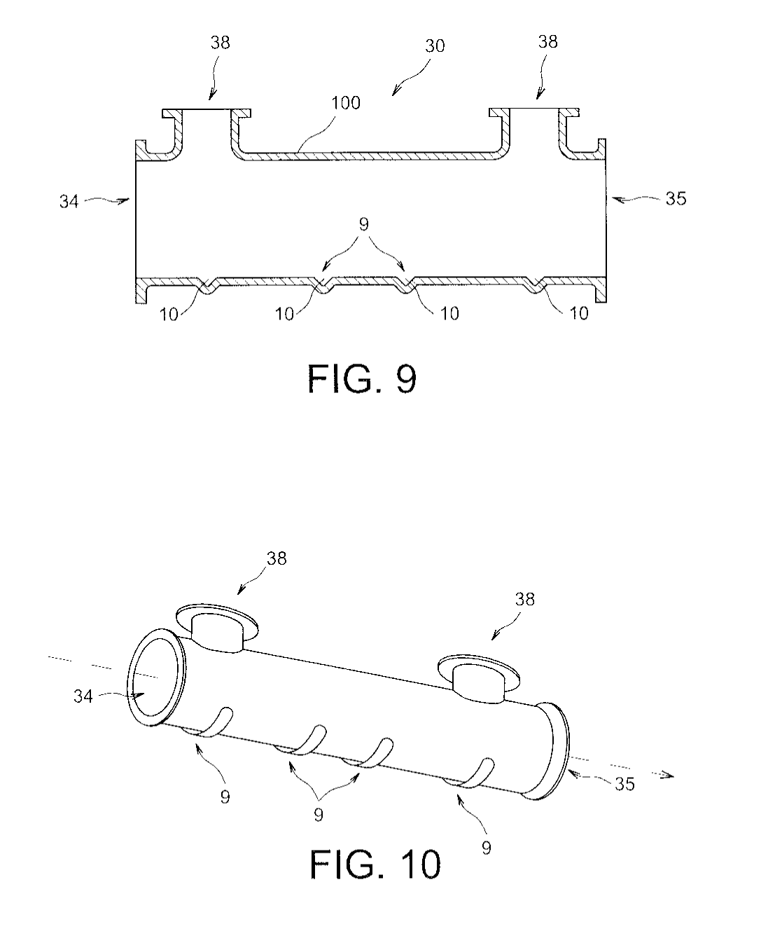

FIG. 9 illustrates a tank 30 having four particle traps 9 and being made of a single piece 100. FIG. 10 shows a perspective view of this embodiment.

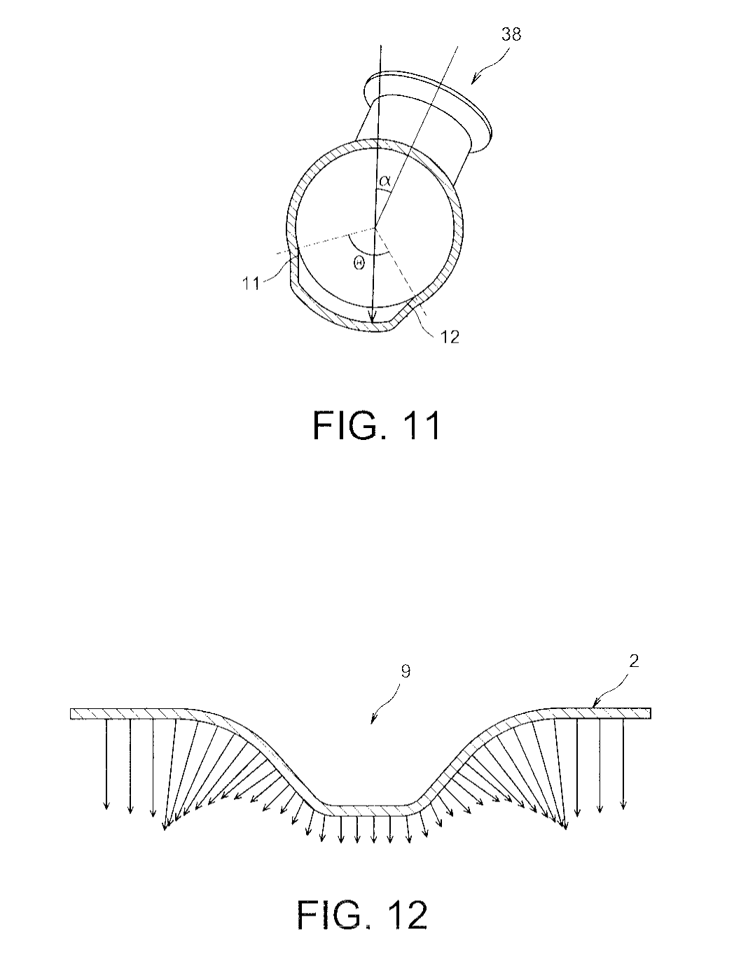

In FIG. 11, the two set apart points 11, 12 of the groove are represented. The tank is represented inclined of an angle α around its main axis and even then, the groove is present at the bottom wall of the tank intersecting a vertical axis and particles can fall therein and be trapped. When tanks are assembled to a circuit breaker frame as represented in FIG. 4, they may need to be oriented at an angle as much as 30° from the vertical position. According to the invention, the particle traps are designed such that a portion of the groove is always at the wall of the tank located at the six o'clock position. As the inclination of the tank varies between 15 and 45°, the angular distance θ at the main axis of the tank between the two set apart points is comprised between 40 and 100°. According to the invention, as the particle trap is a groove which length covers all different possible orientations of the tank, the advantage is that a single tank design can be used for all positions.

Furthermore, according to the invention, the particle trap design guarantees effective collection of all particles, since electric field intensity will increase monotonically towards the trap, in the direction of the highest electric field on the tank as illustrated in FIG. 12. It is known that particles migrate towards higher stressed areas when placed in an electrical field. The grooves forming the particle traps according to the invention are strategically placed such that the stress along the bottom of the tank gradually increases to a maximum stress right at the entrance to the groove. The idea behind the design of the particle trap is that the particle, lying on the bottom of the tank, will move towards the particle trap due to the electrical field. Once the particle reaches the highest stressed location (i.e. the entrance of the particle trap), it slides into the trap into a very low stressed area.

The particle traps are located in priority close to the highest dielectrically stressed live parts of the circuit breaker. That is the reason why the at least two particles traps of the tank are preferably located in the central section area of the tank, where the interrupter chamber of the circuit breaker is located. Furthermore, the particle traps are preferably located in such a manner that the gas exhaust from the interrupter chamber does not cause the particles to be blown out of the trap during breaker operation.

In addition to the particle traps located in the central section area of the tank, particle traps can also be located in the end section area, thus providing coverage near the interrupter gap and at both interrupter ends.

According to the invention, the particles fall to the six o'clock position; then, when the circuit breaker is energized, the particles move from low to high electric field regions on the tank inner bottom surface. As they move to this location, the particles will fall into the groove to a low stress area. The trap then collects and hides the particles, preventing them from compromising the integrity of the gas insulation between the tank and the interrupter.

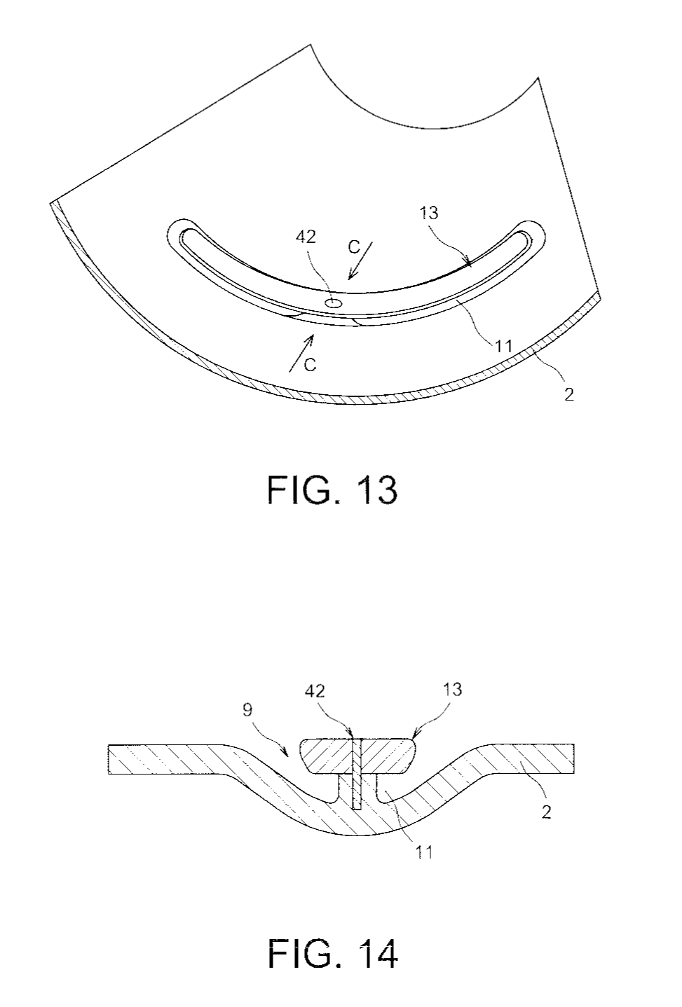

As illustrated in FIG. 13 and FIG. 14, a metallic shroud cover 13 is mounted in the groove (in this embodiment, a plot has been manufactured at the center of the groove to fix the cover to the tank with a screw 42), connected to the tank and at ground potential. The shroud cover reduces the electric field in the groove to or near zero to prevent excitation of the particles that have been trapped and serves as deflector to minimize the effects of any gas flow in stirring the particles out of the trap.

It will be appreciated by those of ordinary skill in the art that the exemplary gas exhaust devices described therein can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

### LIST OF DESIGNATIONS

1 manufactured piece
2 wall of the piece
3 cavity of the piece
4;5 ends of the piece
6 top of the piece
7 bottom of the piece
8 opening of the piece
9 particle trap
10 groove
11;12 set apart points of the groove
13 shroud covering
19 well-shaped particle trap of the prior art
20 main axis of the piece
29 channel-shaped particle trap of the prior art
30 tank
31 casing of the tank
32 inner wall of the tank
33 interior chamber
34;35 ends of the tank
36 top of the tank
37 bottom of the tank
38 opening of the tank
39 frame
40 pole
41 three-phase circuit breaker assembly
42 screw
100 manufactured piece

1. A manufactured piece of a tank made by casting or molding for a high-voltage circuit breaker, having:
a hollow body with at least one wall extending longitudinally along a main axis to delimit a cavity with two ends, a top and a bottom;
at least one opening in the top of the body; and
at least one particle trap in the bottom of the body for collecting particles;
wherein the particle trap is a groove extending between two set apart points belonging to a plan perpendicular to the main axis.

2. The manufactured piece of claim 1, wherein the groove extends in a plan perpendicular to the main axis.

3. The manufactured piece of claim 1, wherein the groove is defined by the wall of the body and opens to the cavity.

4. The manufactured piece of claim 1, wherein an angular distance at the main axis of the body between the two set apart points is comprised between 40 and 100°.

5. The manufactured piece of claim 1, wherein the groove has a width to depth ratio comprised between 0.5 and 3.0.

6. The manufactured piece of claim 1, wherein the body is generally cylindrical in shape.

7. The manufactured piece of claim 1, further comprising a covering shroud placed at a particle trap, said shroud being formed with a shielding surface for dielectrically shielding an area between the covering shroud and a bottom of the groove.

8. The manufactured piece of claim 7, wherein the body is generally cylindrical in shape and a top surface of the covering shroud is flush with a surface of the body wall around the groove.

9. A tank for a high-voltage circuit breaker, having a casing with at least one inner wall extending longitudinally along an axis to delimit an interior chamber with two ends, a top and a bottom, two particle traps in the bottom of the casing and two openings in the top of the casing, wherein the tank comprises a manufactured piece having:
a hollow body with at least one wall extending longitudinally along a main axis to delimit a cavity with two ends, a top and a bottom;
at least one opening in the top of the body; and
at least one particle trap in the bottom of the body for collecting particles;
wherein the particle trap is a groove extending between two set apart points belonging to a plan perpendicular to the main axis and wherein the cavity of the hollow body forms at least part of the interior chamber of the tank.

10. The tank of claim 9, wherein the tank contains one manufactured piece, the interior chamber of the tank corresponding to the cavity of the manufactured piece.

11. The tank of claim 9, wherein the tank contains two manufactured pieces, the interior chamber of the tank corresponding to two cavities and resulting from the assembling of one end of a first manufactured piece with one end of a second manufactured piece.

12. The tank of claim 11, wherein the first and second manufactured pieces are identical.

13. The tank of claim 9, wherein the interior chamber is composed of section areas arranged longitudinally along the axis of the casing, with two end section areas at the ends, two opening section areas at the openings and a central section area, each opening area being located between an end section area and the central section area, and wherein the two particle traps are located in the central section area.

14. The tank of claim 13, wherein the tank further comprises two additional particle traps, an additional particle trap being located in each of the two opening section areas.

15. A high-voltage gas-insulated circuit breaker comprising an interrupter chamber enclosed in a tank filled with insulating gas, wherein the tank is a tank according to claim 9.
